(19) United States
(12) Patent Application Publication
(10) Pub. No.: US 2026/0336845 A1
(43) Pub. Date: Oct. 29, 2026

(54) DRONE CHARGING APPARATUS FOR CHARGING DRONES AT AN ELEVATED LOCATION

(71) Applicant: Buoyant Aircraft Systems International Inc., Winnipeg (CA)

(72) Inventor: Dale A. George, Tiny Township (CA)

(21) Appl. No.: 19/642,793

(22) Filed: Apr. 9, 2026

Related U.S. Application Data
(60) Provisional application No. 63/794,918, filed on Apr. 25, 2025.

(51) Int. Cl. B64U 80/25; B64U 50/37; B64U 70/99

(52) U.S. Cl. CPC B64U 80/25; B64U 50/37; B64U 70/99

(57) ABSTRACT

A drone charging apparatus includes (i) a mounting frame attached to the drone and defining a connecting portion forming a catch and first electrical terminals thereon and (ii) a docking station mounted on an elevated supporting structure such that the drone can approach the docking station from below in which the docking station includes a receiver forming a socket with a latch and second electrical terminals thereon. The drone flies upwardly to dock the connecting portion of the drone mounting frame into the docking station socket until the catch can be retained by the latch and the electrical terminals align for charging. The drone is thus supported at elevation under a roof of the docking station from which the drone can be safely suspended to be protected from vandalism or weather using a simple inexpensive structure, while enabling quick release to resume flight when desired.

This application claims the benefit under 35 U.S.C.119(e) of U.S. provisional application Serial No.63/794,918, filed Apr. 25, 2025.

### FIELD OF THE INVENTION

The present application relates to a docking apparatus for a drone that provides electrical charging to the drone, and more particularly, the present invention relates to an air-to-air drone docking and charging apparatus that receives a drone flying up into a guiding structure and that includes a mechanical capture mechanism that both retains the drone and provides electrical connections to re-charge the drone.

### BACKGROUND

Drone recharging devices such as ground based platforms are existing products that sometimes are used in inclement weather and in locations where vandalism can be high. Therefore, they are at high risk of wear and vandalism attack making them somewhat unreliable. The materials used in these ground-based devices require a certain level of maintenance because they often have elaborated mechanical protection systems including large closing doors that cover the entire drone to be enclosed within the charging device. The recent trend to offer better recharging stations has aggravated this problem where many drone operators are seeking a better solution. In particular, some drones do not receive adequate recharging from small movements of the conductive pins moving on the recharging plates or tiles of these existing stations causing the battery charger to disconnect electronically. This event means the battery does not get recharged until someone manually resets the charger. This condition also upsets the normal charge capacity of the battery causing less current resulting in less flight times. In most cases the battery and charger can detect very small changes in the connection voltage and any small changes the battery rejects the charger to ensure the battery is protected by poor voltage and current conditions. These charging systems are referred to as, “smart” battery systems to maintain new battery chemistry such as Lithium. These existing ground-based chargers are expensive and do not have a long lifespan due in art to poor weather protection during opening and closing to allow the drone access to the sky.

Problems with exiting ground-based recharging stations including the following: (i) Vandalism is a potential threat because the station can only be protected by a fence or other structures that are too high to surmount. (ii) Not protected from weather elements unless some elaborate closing roof mechanism has been installed. (iii) Lack of good connectivity with the charging platform. In some cases, the drone does not make a solid contact with both positive and negative terminals. (iv) Damage can result, if the drone contacts the closure mechanism during takeoff and landing in gusty wind conditions. (v) It is difficult and expensive to maintain multiple changing stations because of size and complexity. (vi) The elaborate roof and closing mechanism is susceptible to the weather (ice and snow) and must be maintained making it difficult to use in isolated areas.

### SUMMARY OF THE INVENTION

One aspect of the invention relates to a charging apparatus for charging a drone relative to a supporting structure at an elevated location using a power supply in which the charging apparatus comprises:
a mounting frame arranged for attachment to the drone to extend upwardly above the drone;
a catch formed on a connecting portion of the mounting frame;
first terminals mounted on the mounting frame so as to be arranged for electrical communication with respective charging terminals of the drone;
a docking station arranged to be mounted on the supporting structure at said elevated location such that the drone can approach the docking station from below;
a receiver on the docking station including a socket arranged to receive the connecting portion of the mounting frame inserted upwardly therein in a docked position of the mounting frame relative to the docking station;
second terminals arranged for connection to the power supply, the second terminals being mounted on the docking station so as to be arranged for electrical communication with the first terminals respectively in the docked position of the mounting frame relative to the docking station whereby the charging terminals of the drone are charged from the power supply; and
a latch mounted on the docking station so as to be operable between (i) a latched configuration engaged with the catch on the mounting frame so as to retain the mounting frame in the docked position and (ii) a released configuration in which the mounting frame is freely movable downwardly from the docked position to allow withdrawal of the mounting frame from the receiver on the docking station.

According to a second aspect of the present invention there is provided a method of docking a drone relative to a supporting structure at an elevated location for charging the drone using a power supply, the method comprising:
providing a mounting frame attached to the drone to extend upwardly from the drone in which the mounting frame includes a connecting portion forming a catch thereon and first terminals for electrical communication with respective charging terminals of the drone;
providing a docking station mounted on the supporting structure at said elevated location such that the drone can approach the docking station from below, in which the docking station includes a receiver forming a socket therein, second terminals connected to the power supply, and a latch;
operating the drone to fly upwardly towards the docking station such that the connecting portion of the mounting frame is inserted upwardly into the socket of the receiver into a docked position of the mounting frame relative to the docking station; and
operating the latch on the docking station from (i) a released configuration in which the mounting frame is freely movable downwardly from the docked position to allow withdrawal of the mounting frame from the receiver on the docking station and (ii) a latched configuration engaged with the catch on the mounting frame so as to retain the mounting frame in the docked position;

wherein the first terminals of the mounting frame electrically communicate with the second terminals on the docking station in the docked position whereby the charging terminals of the drone are charged from the power supply.

Providing a device that captures and provides weather and vandal protection to the drone while rechanging, is very desirous. The disclosed exemplary and complimentary embodiments provide a device in which all aspects of recharging a drone are expressed by the use of a unique capture and release mechanism along with providing protection form the drone. In one embodiment the capture structure is shaped much like a funnel-like structure which allows the probe and ball mounted to the drone, easy access to the locking and recharging systems. The probe is mounted to a quadpod that is secured to the arms of the drone as where the motors are located. This provides a very secure device from where to mount the probe. A ball-like structure is provided at the end of the probe by which electrical current is passed thereby recharging the drone battery.

Solutions offered by using a drone charging apparatus include the following: (i) Vandalism is very low since the drone charging apparatus is mounted in higher more difficult to access points such as bridge underpasses, poles, light stands, side of buildings, on aerostats and airships. (ii) A simple low-cost plastic canopy covers the drone like an umbrella protecting it from the elements. It is made of 6 to 8 sections that are bolted together to form a circular enclosure. (iii) The probe and ball/socket connection between the drone and the charging station, ensure a strong electrical connection primarily from the weight of the drone and the contact it makes through the ball and socket formed from the jaws of the capture mechanism. (iv) The drone can never come in contact with the charging system since it drops away from and flies up to land much like a bat does during resting. The drone is in a stable hover before it slowly ascends to connect with the charger. It is guided by use of a funnel that ensures the charging connection is securely made. (v) The simplicity and lack of complicated mechanisms make the drone charging apparatus less expensive.

Further devises, features, advantages and descriptions of the device according to the present application will become apparent from he detailed descriptions and claims.

In the illustrated embodiment, the receiver is preferably tapered upwardly and laterally inwardly towards the socket to guide insertion of the connecting portion of the mounting frame upwardly into the socket of the receiver as the mounting frame is displaced towards the docked position.

The receiver preferably includes a guide wall that is generally conical in shape so as to guide insertion of the connecting portion upwardly and laterally inwardly from all directions towards the socket.

The guide wall may be generally convex along at least a portion of a height of the guide wall between a bottom peripheral edge of the guide wall and the socket at a top end of the guide wall.

Preferably the receiver receives the connecting portion of the mounting frame therein in the docked position such that the mounting frame is suspended from the receiver and is able to be deflected laterally in all directions from the docked position by pivoting of the mounting frame about a central point of the connecting portion received within the socket.

A top of the connecting portion may be tapered upwardly and inwardly in all direction towards a central apex of the connecting portion.

The latch is preferably horizontally slidable between the latched configuration and the released configuration.

Preferably, the catch extends 360 degrees about an upright axis of the connecting portion of the mounting frame.

The connecting portion of the mounting frame may further comprise an upright post.

The catch may be defined as a bottom surface of a radial enlargement formed on the upright post. The bottom surface of the radial enlargement is preferably tapered downwardly and inwardly about a full circumference of the upright post.

The mounting frame may further comprise a plurality of radial supporting arms arranged for connection between the upright post and respective frame arms of the drone.

The upright post may comprise a hollow tube receiving electrical wiring communicating therethrough between the first terminals of the mounting frame and the charging terminals of the drone.

The first terminals may be supported on the mounting frame above the catch.

The first terminals may include a positive terminal and a negative terminal which are vertically spaced apart from one another, in which one of the first terminals may be defined at a top end of the mounting frame and one of the first terminals may be defined by the catch.

A roof structure is preferably mounted in fixed relation to the docking station in which the roof structure is sized to fully span over the drone in the docked position of the mounting frame relative to the docking station.

The roof structure preferably extends downwardly to a bottom peripheral edge arranged to be located below a portion of the mounting frame in elevation so as to be arranged to at least partial shelter the drone in a lateral direction.

### BRIEF DESCRIPTION OF THE DRAWINGS

One embodiment of the invention will now be described in conjunction with the accompanying drawings in which:

FIG. 1 is a perspective view of the drone charging apparatus according to a first embodiment of the present invention, illustrating a mounting frame for attachment to a drone and a docking station to be mounted on a supporting structure at an elevated location,

FIG. 2 is an exploded view of the latch of the docking station and the connecting portion of the mounting frame according to the first embodiment of FIG. 1; and

FIG. 3 is a perspective view of the mounting frame shown separated from the drone in a mounted position relative to the latch of the docking station according to the first embodiment of FIG. 1.

In the drawings like characters of reference indicate corresponding parts in the different figures.

### DETAILED DESCRIPTION

In the following detailed description, the device according to the teachings for this application in the form of a drone recharging station will be described by the embodiments. It should be noted that although only a drone recharging station is described, the teachings of this application can also be applied to any drone and can be used in many applications such as security, surveillance, law enforcement, scientific and many such applications.

Referring to the accompanying figures there is illustrated a drone charging apparatus 240. The apparatus is arranged for charging a drone 200 in a docked and mounted position of the drone relative to the apparatus.

The drone 200 according to the illustrated embodiment is a conventional drone comprising a central hub 242 containing a circuit board with a processor and a memory storing programming instructions arranged to be executed by the processor to execute various operating instructions of the drone in the usual manner. A set of four drone arms 201 extend radially outwardly from the central hub to distal ends of the arms, each supporting a respective motor thereon that drives a rotor 244 or propeller under control from the central hub to achieve flight. The electronics within the central hub and the motors receive electrical power from an onboard battery which can be charged from an external source connected to charging terminals of the electronics of the hub. A set of legs 246 are shown depending downwardly from the central hub for supporting the drone on a suitable supporting surface when not in flight.

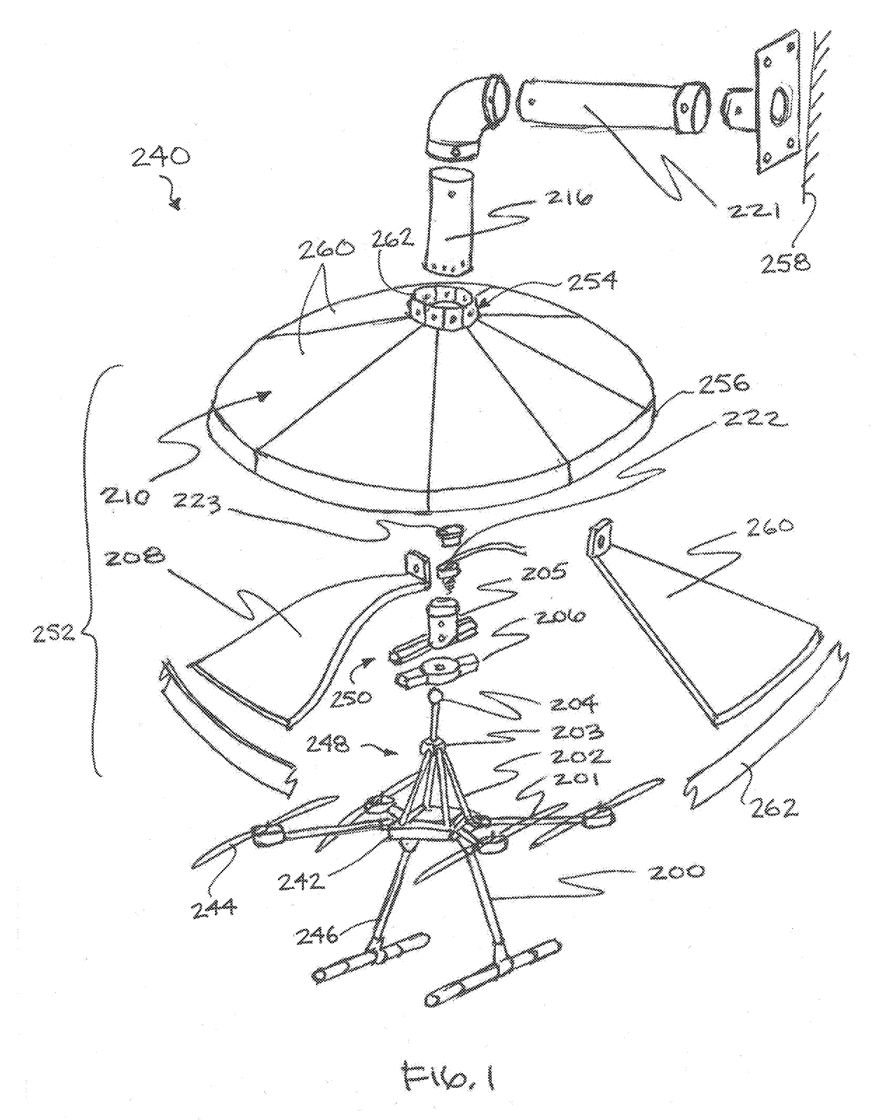

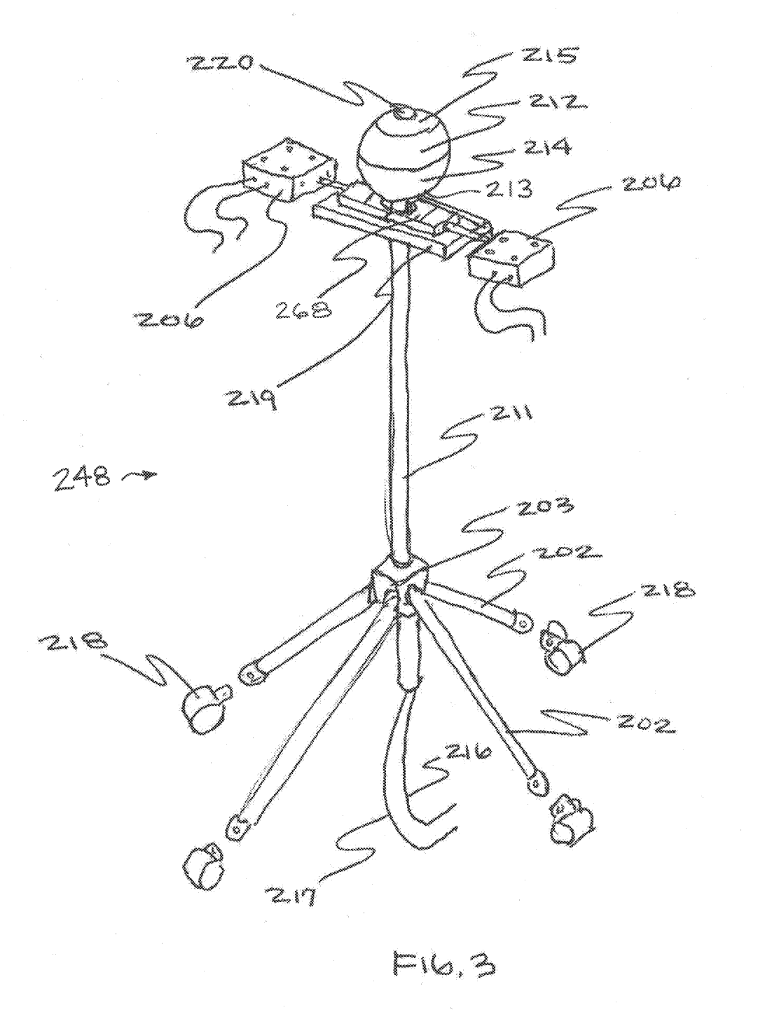

The drone charging apparatus according to the present invention generally includes (i) a mounting frame 248 for attachment to the drone 200 and (ii) a docking station 250 for mounting onto a suitable supporting surface at an elevated location for releasable connection to the mounting frame to suspend the drone 200 from the docking station in a docked and mounted position of the drone. The mounting frame, shown primarily in FIG. 3, serves to define a connecting portion 204 with a catch 213 thereon at a location supported spaced above the central hub and rotors of the drone 200 from which the drone can be suspended in the docked position. The docking station represented in FIG. 1 includes a receiver 208 for guiding the connecting portion 204 into a socket 205 of the docking station that receives the connecting portion 204 therein in the docked position. The docking station further includes a latch 206 with a suitable retention surface thereon in which the latch is operable into a latched position for retaining the catch 213 of the connecting portion 204 on the retention surface of the latch 206 in the docked position to retain the connecting portion within the socket. The socket 205 is open at a bottom to receive the connecting portion 204 of the mounting frame inserted upwardly into the socket to mount the drone relative to the docking station in the docked position and to allow the drone to be released downwardly from the docking station upon displacing the latch 206 into unlatched or released position.

The mounting frame includes a central mounting hub 203 in the form of an adjustable mounting bracket that mounts four supporting arms 202 thereon. The arms 202 are connected to the central hub 203 for relative pivotable movement so as to enable the angular inclination of the arms relative to one another and relative to the bracket to be adjusted. The arms 202 may also be adjustable in length and fixed at any desired length within a range to provide further adjustability of the mounting frame. A series of brackets 218 are mounted at the distal ends of the supporting arms 202 in which each bracket 218 comprises an adjustable clamp or clasp arranged to be mounted onto a respective one of the drone arms 201 at the proximal end of the drone arm adjacent to the central control hub of the drone 200. The connection of the support arms 202 to the respective brackets 218 is also pivotable to enable angular adjustment of the brackets 218 relative to the arms 202. In this manner, the mounting frame is highly adjustable and adaptable to a variety of frame configurations of the drone 200.

The mounting frame also includes a central post 211 in the form of a vertical shaft adjustably mounted at a lower end on the central mounting hub 203 of the mounting frame to extend vertically upward therefrom to mount the connecting portion 204 of the top end of the post 211 at a location spaced above the top of the drone 200. The post 211 is a hollow tube defining an internal conduit therethrough to receive wiring as described in further detail below. The adjustability between the brackets 218 and the arms 202 as well as the adjustability of the arms 202 relative to the central hub 203 and the adjustability of the central post 211 relative to the hub 203 allows the connecting portion 204 at the top of the post 211 to be centred horizontally in lateral and longitudinal directions relative to the drone below so that the connecting portion 204 can be located directly above the centre of gravity of the drone 200 below to optimally suspend the drone 200 from the connecting portion 204 in the docked position.

The connecting portion 204 in the illustrated embodiment is a spherical ball shaped body which is mounted coaxially at the top end of the post 211 below. The connecting portion has a larger diameter than the post below such that the connecting portion defines a radial enlargement relative to the central post 211 having an undercut bottom surface that defines the catch 213 on the connecting portion 204. The bottom surface of the ball defining the connecting portion 204, and which defines the catch 213 thereon, protrudes in a uniform manner about the full circumference of the post 211 so that the catch 213 extends 360 degrees about the post and is evenly sloped upwardly and radially outwardly in all directions from the top end of the post 211.

Likewise, the top of the ball forming the connecting portion 204 is similarly tapered in all directions upwardly and radially inwardly towards a central apex so that engagement of the top of the ball with an underside of the docking station acts to guide the connecting portion 204 upwardly and radially inwardly into alignment with the socket for docking as described in further detail below.

The connecting portion 204 is structured in layers including a lower tier formed of a conductive material and defining the bottom surfaces of the catch 213 so as to act as a negative electrical terminal 214. A top tier is also formed of a conductive material so as to define a positive electrical terminal 215 while defining the top surface of the ball that tapers towards the central apex. A middle tier is located immediately above the lower tier and below the upper tier to extend about the full circumference of the connecting portion 204 while being formed of an electrically insulating material so as to function as an electrical isolator 212 between the negative terminal 214 and the positive terminal 215. In this arrangement, the electrical terminals are vertically spaced apart at different elevations while each extending about the full circumference of a vertical axis of the connecting portion 204. The positive terminal 215 is also defined at a location spaced above the catch 213 formed on the bottom surface of the connecting portion 204.

A positive electrical lead 216 is threaded through the hollow interior of the central post 211 for connection internally to the positive terminal 215 at the top of the connecting portion 204 and for connection to a corresponding positive charging terminal of the drone 200 below. Likewise a negative electrical lead 217 is also threaded through the hollow interior of the central post 211 for connection internally to the negative terminal 214 at the bottom of the connecting portion 204 and for connection to a corresponding negative charging terminal or a grounded frame of the drone 200 below.

A top contact 220 is located at the top of the connecting portion 204 which forms initial contact within the socket of the docking station when docking and can be used as a trigger for detecting when the connecting portion 204 has been fully inserted into the socket of the docking station.

The docking station includes a series of frame members 216 and brackets 221 which are arranged to be secured in fixed relation to the supporting surface such as an upright wall and the like so that the frame members protrude horizontally outward from the supporting surface upon which it is mounted for suspending the remainder of the docking station therefrom. The frame members 216 and the bracket 221 include hollow passages formed therethrough to allow for wiring to be received therethrough for connection between a public electric utility and a battery charging unit 207 supported internally within the docking station for forming an electrical connection with the electrical terminals on the mounting frame for charging the drone 200.

The docking station primarily comprises a receiver 252 that receives the connecting portion 204 in the form of an inner guide wall 208 having an inverted cone shape that tapers upwardly and inwardly to a central apex 254 and towards the socket 205 mounted at the apex of the conical guide wall 208 and having an open bottom which is open to the hollow interior at the interior of the inner guide wall 208. The guide wall 208 thus forms an inner cone structure which tapers upwardly and radially inwardly from a bottom peripheral edge 256 to a central opening at the apex that is aligned with the bottom opening of the socket 205 receiving the connecting portion 204 inserted therein in the dock position. The inner guide wall 208 may be at least partly convex in profile along the height of the wall between the bottom peripheral edge and the central opening at the apex.

The docking station also includes a roof structure 210 defining an outer cone structure above and to the exterior of the inner guide wall 208. The outer cone structure defined by the roof structure 210 is a similar inverted cone shape to be sloped upwardly and radially inwardly from a respective peripheral edge connected to the bottom peripheral edge of the inner guide wall 208 to a central apex aligned with the apex of the inner guide wall 208 at a location spaced thereabove. The central apex of the roof structure 210 is adapted for mounting to the frame members 216 to suspend the inner guide wall 208 and the outer roof structure 210 from the frame members 216 which are in turn fixed to the rigid supporting surface 258 of an elevated structure spaced well above ground and mounting the docking station thereon. The space between the inner guide wall 208 and the outer roof structure 210 defines a hollow interior of the docking station which provides added protection and some insulating value to shield the drone 200 when docked within the interior of the inner guide wall 208.

The battery charging unit 207 of the docking station may be protected within the hollow interior of the frame members 216 or within the hollow interior between the inner guide wall 208 and the outer roof structure 210. Electrical wiring is communicated as well through the interior spaces in a protected manner for connection to respective charging terminals of the docking station at the location of the socket 205 for conductive communication with respective terminals 214 and 215 on the mounting frame in the docked position of the drone relative to the docking station. A spring loaded contact is mounted at the inner terminal end of the socket 205 and is axially movable but biased down into engagement with the top of the connecting portion 204 in the docked position. The spring-loaded contact may form the positive terminal of the docking station that is in conductive communication with the positive terminal 215 on the connecting portion in the docked position.

A small electrical contact point 220 is located at the top of the connecting portion 204 that when contacted by a corresponding electrical circuit contact point 222 at the top of the socket 205 to complete an electrical connection serves as a trigger to activate the locking device 206 and begin the charging procedure. An access and locking cap 223 is located at the top of the housing of the socket 205 to position and lock the contact 222 in its position. Electrical commands are given through contact 222 to reverse the docking procedure by giving a command to the latch 206 to release the drone 200. It is also used to unlock and activate the drone 200. Software executed on a controller of the docket station detects when this contact has been made to also provide information to the flight operations command center which can be several km away. The electrical contact point 220 one the drone also gives inputs to the flight controller when the drone is actually locked in the socket assembly.

Both the conical structure of the inner guide wall 208 and the conical structure of the roof structure 210 are formed in pie shaped or triangular modular sections 260 that each span from the respective peripheral edge to the apex so as to be joined adjacent to one another in the circumferential direction. The modular sections are also joined to one another by annular bands 262 coupled to the modular sections about the bottom peripheral edge and about the respective openings at the apex.

The latch assembly 206 of the docking station which selectively latches the connecting portion 204 relative to the docking station is primarily comprised of two latch members which engage diametrically opposed locations of the mounting frame to latch the connecting portion 204 within the socket 205. Each latch member comprises a jaw 264 which is linearly slidable along a common horizontal axis of the latch 206 which extends diametrically across the socket 205. The jaws are connected to respective linear actuators 266 which drive the jaws (i) towards one another from opposing sides of the central post 211 to clamp the post therebetween in the latched position while displacing the jaws outwardly and away from one another into the unlatched position. The jaws engage the post immediately below the connecting portion 204 such that upper surfaces of the jaws define the retaining surfaces 268upon which the catch 213 is engaged in the latched position to prevent removal of the connecting portion 204 from the socket 205.

Each jaw has an inner clamping face which is notched to define a recess 270 receiving approximately half of the cross section of the post 211 recessed therein when the jaws are clamped such that the recesses collectively define a central opening size to receive the entirety of the post 211 extending therethrough in the latched position. In the unlatched position, the jaws are spaced sufficiently apart that the bottom opening of the socket is fully unobstructed by the latch and the jaws are spaced by a distance greater than the diameter of the connecting portion 204 to allow ready downward release of the connecting portion from the socket in the unlatched position as well as allow ready insertion of the connecting portion 204 upwardly into the socket when docking. Upon initial insertion of the connecting portion 204 into the socket, the latch 206 may be closed towards the latched position even when the connecting portion 204 is not fully inserted into the socket 205 due to the tapered bottom surface of the connecting portion 204 which when engaged by diametrically opposing jaws causes the jaws to slide along the tapered surfaces and urge the connecting portion further into engagement within the socket. This also firmly engages the retaining surfaces on the upper surfaces of the jaws with the corresponding catch 213 formed on the bottom of the connecting portion 204. The retaining surfaces on the upper surfaces of the jaws may also be connected to the ground or negative terminal of the battery charging unit 207 of the docking station to form the negative terminal connection between the docking station and the mounting frame on the drone for charging in the docked position.

The jaws of the latch 206 are supported for linear sliding on respective guide rails 219 which extend linearly in the sliding direction of the jaws at laterally spaced positions to receive opposing edges of the jaws for sliding movement along the rails. The guide rails 219 thus define a track that supports the jaws for linear sliding movement relative to the fixed components of the docking station between the latched and unlatched positions.

When docking a drone relative to the docking station, the drone is given flight instructions to fly upwardly to guide the connecting portion 204 up into the hollow interior of the inner guide wall 208 of the receiver. Upon engagement of the tapered top surface of the connecting portion 204 with the sloped guide wall 208, continued upward motion of the drone will automatically centre the connecting portion 204 relative to the socket 205 for inserting the connecting portion upwardly into the socket. The contact 220 at the top of the connecting portion 204 forms contact with the inner terminal end of the socket in the docked position to confirm full insertion of the connecting portion 204 within the socket 205 to trigger closing of the latch 206 into the latched position. Operation of the propellers of the drone can then cease as the drone is fully supported in the docked position by the catch 213 on the bottom surface of the connecting portion 204 being engaged upon the retaining surfaces on the top side of the jaws of the latch 206.

The post 211 extends through the central opening in the latch 206 in the latched position with sufficient clearance to allow some relative pivotal movement of the central post 211 in all directions from a central vertical axis orientation within the docking station. Likewise the central post has a sufficient length and the diameter of the inner guide wall 208 of the docking station is sufficiently large that there is clearance on all sides of the drone relative to the docking station when supported vertically so that the drone can be deflected off axis in any direction by several degrees without any contact of the propellers with the docking station. The bottom peripheral edge of the inner guide wall 208 and the roof structure 210 is located sufficiently radially outwardly and downwardly relative to the docked drone to at least partially surround the drone in the lateral direction and to extend downwardly over part or all of the height of the drone in the docked and mounted position of the drone within the docking station.

Due to the charging terminals 214 and 215 extending about the full circumference of the connecting portion 204, the charging terminals are arranged to form an electrical connection with corresponding charging terminals on the latch 206 and within the socket 205 to form a suitable electrical connection for charging the drone regardless of the orientation of the drone about a vertical axis of the socket.

When the drone has been fully charged and is ready for deployment, the drone is activated by driving the propellers to generate lift followed by opening of the latch 206 into the unlatched position so that subsequent flight instructions can be directed to the drone to engage in a downward controlled flight path to exit the boundary of the docking station before resuming other flight instructions.

As described herein, the drone charging apparatus uses a unique battery charging / recharging system by using a “hanging” method rather than the existing ground-based platform resting technology. The unique probe and ball of the drone charging apparatus is captured by a flying drone with the aid of a simple funnel and catch mechanism. The electrical connection is made through the ball with exerts a strong contact for the electrical current once the drone has been captured. This ensures a good charge is being made by maximizing the weight on the contact points. A simple spring-loaded upper contact ensures the secondary positive contact is made. A voltage sensor is provided to let the drone know it has been fully charged and ready for flight. The drone receives a signal to start flight by rotating its propellers and a short time later the release signal to the latch is given. The drone then drops away from the drone charging apparatus and another signal is given to immediately start the flight. The drone operator can use the existing flight data logger to program the location of the ball on the drone charging apparatus. The location of the drone charging apparatus would be a waypoint and act as the starting point and return-home point. Should the drone be operating beyond the range of its battery level, it will return to the nearest location of the drone charging apparatus should one be made available. Multiple locations of drone charging apparatuses will ensure that the drone can extend its distance by travelling from apparatus to apparatus. A map of multiple apparatuses could be supplied to many operators who could provide a very large surveillance area in comparison to one without. This map could also be shared by regional operators who would otherwise not reach distant regions without the use of the drone charging apparatuses could also be made available over long periods of time be being on the ready for deployment in the event the drone is required. This means a pilot does not need to drive to a distant location but rather just look at the location of drone charging apparatuses and select which area they need to cover. The drone charging apparatuses could be mounted almost anywhere making the drone more effective and provide a lower cost alternative to a manned operation. The drone charging apparatus also provides a higher level of security to the drone itself.

In use the drone flies up to and directly below the funnel shaped enclosure apparatus where it hovers briefly with out any forward, backward or left or right movements before it continues slowly and steadily upward into the funnel until it is captured by a locking mechanism located directly under the ball that is located at the end of the rod or post. The tapers on the arms of the locking mechanism slightly moves the drone upwards to ensure there is a positive connection between the ball and the socket that contains the pressure contact spring and the charger terminal. This is the positive lead from the charger. The battery charger senses the drone is connected by sensing the voltage and electronically reads the battery to determine its safe before the recharging process begins. The drone’s motors are stopped the moment the locking mechanism on the device senses the drone is secure. The motors are stopped, and the recharging begins. Batteries of a high discharge C rate can be quicky recharged over batteries with a lower C rate. The reverse sequences occur when the drone returns to flight.

In another embodiment the drone can move about the ball locking mechanism without electrical change due in part to the high forces directed by the weight of the drone through the contact point.

The drone charging apparatus is a new way of recharging electric vertical takeoff and landing, known as, VTOL drones by flying the drone to a permanently installed and elevated charging system that captures the drone from a unique top mounted probe that is secured to the drone’s arms by clamps and fasteners that wrap around the arms of the drone that help secure the drone while charging.

The drone charging apparatus system greatly extends the range of the drone to at least 2x the distance by providing a “leap-frog” approach to recharging the battery. The drone simply flies to the next drone charging apparatus. By using multiple drone charging apparatuses, a single drone can now provide long range surveillance.

The drone is captured by a locking system that is activated when the probe secured to the drone enters the charging systems funnel. The ball mounted at the end of the probe provides both the positive and negative battery connections. A further battery balancing connection can be provided.

The drone is released into the air from a simple “fly now” command that starts the motors just when the drone is released. The drone drops away from the charging system and continues its mission. The reverse happens when the drone requires recharging.

According to the illustrated embodiment, the drone recharging station comprises a housing enclosure structure that can be secured to posts, bridges, sides of buildings, and other like structures. The drone is of a typical four motor design and utilizes four arms to support the motors and propellers. Other shapes and sizes can use the same system by slightly changing the relationship between the mounting frame and the arms of the drone. The drones’ arms are used to secure the charging probe assembly to the drone by using the existing arms supplied from the manufacturer and clamps. Arms radiating out from the drone that are secured to the drone arms and the probe assembly support arms make up the probe assembly. The support arms are adjustable to allow the probe assembly to be centered over the body of the drone. There is provided a central machined bracket on the mounting frame that is required to secure each of the supporting arms to the probe and allow for adjustment. Movements up and down can be made from adjustments made through the central bracket.

The probe assembly includes a ball made up of three parts: the positive terminal layer, the negative terminal layer and an electrical isolator layer between the electrical terminal layers located on a top end of the probe shaft that supplies power from the changer to the drone from power cables that are located within the tube of the shaft. There is provided a termination contact that comes in contact with the positive terminal from the drone and that forms the positive electrical lead of the charger to come in contact with the ball. It is activated when the ball is sufficiently in contact with the drone. A signal is given from the contact being made from a sensor located within the drone’s control board. The battery charger also senses the correct positive polarity and is ready for the charging signal. The battery cells are balanced by a circuit that is mounted directly to the battery pack,

The latch is a mechanical electric locking mechanism that secures the probe assembly to the changer by sliding two machined slots that capture the probe tube or shaft just beneath the ball of the connecting portion of the mounting frame. The locking mechanism is shaped as to cause a slight interference between the ball and the locking mechanism to ensure a tight contact. A signal is given to the locking mechanism when the probe ball comes in direct contact with the upper limit of the probe. The electrical signal is given to the latch when the drone is suitably located within the upper area of the cone or guide wall of the receiver and is in contact with the charger.

The battery charging unit connects the electrical grid feed supply to the drone battery via the probe assembly. An electrical signal is given to the charger when the drone battery senses it requires charging or is fully charged. The charger has an automated voltage and current sensing software that can detect the proper connection has been made and start the charging sequence to the battery. A high charge rate can be given should the charger detect a high C rate battery.

The receiver of the docking station includes a guide wall in the form of a round funnel shaped structure that allows the probe to be captured by the drone as it raises from underneath. It utilizes a continuously curving surface that terminates and forms a circle at the upper limit of the funnel. The upper locking and charging system contact is located at the upper termination of the funnel structure.

The charger system receives its electrical power from the public grid and is secured to other structures such as but not limited to buildings, posts, towers, bridges and other locations that can be used to extend the range of the drone by allowing the drone to move from charging station to charging station. This is a very desirable advantage from single point charging sites. A simple bolting tube along with other tubing frame members and brackets or clamping systems with fasteners are used to secure the receiver and roof structure of the docking station to these structures. A band that joins sections of the guide wall and roof structure parts using bolts and nuts is provided to form a hollow structure between the guide wall and the roof structure that provides protection to the drone and other components. Elevated locations provide much needed protection to the drone operation from vandalism and space for the drone to be operated. The inner guide wall and the upper roof structure provide a sloped roof type structure that protects the drone from inclement weather and sun.

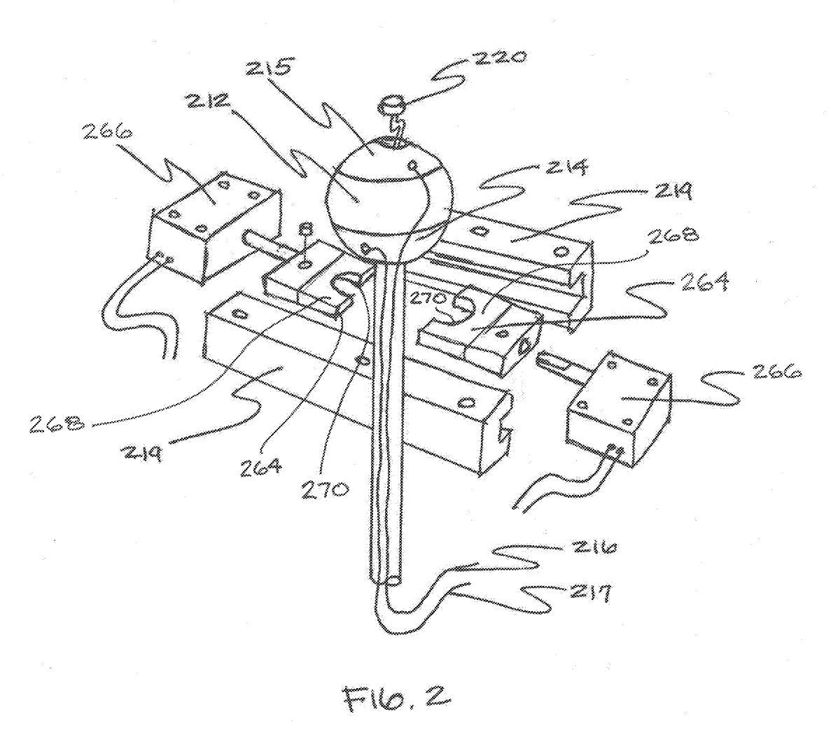

FIG. 2 illustrates the probe tube that is a hollow tube structure that contains the electrical cables and can act as a conduit for additional electrical wires through the charging ball and locking mechanism. The probe assembly is comprised of a tube and ball that is made of three parts. The negative terminal at the tube end, the insulator in the center and the positive terminal at the upper end of the tube. A catch is located at a bottom of the ball in the closed position. The catch also comes in contact with the negative terminal. The catching mechanism of the latch is contained and allowed to slide forwards and backwards within guide rails.

FIG. 3 refers to the probe assembly that houses the charging cables running from the battery charger. A positive electrical lead wire cable runs through the probe tube and terminates at the contact point at the top of the ball of the connecting portion. The intermediate insulated portion of the charging ball and probe assembly isolate the positive and negative electrical wires. The negative terminal is grounded to the drone chassis by corresponding wire through the hollow post of the connecting portion of the mounting frame. The probe support arms secure the probe to the drone. The central connector bracket of the mounting frame is used to secure the probe arms to the central post or shaft of the mounting frame. The central connector backet is adjustably connected to the arms and the central post to aid in centering the drone relative to the connecting portion of the probe assembly and provide support between the drone frame and the connecting portion of the mounting frame from which the drone is suspended when docked. The support arms of the mounting frame are secured to the drone arms through adjustable brackets at the distal ends of the support arms.

Since various modifications can be made in the invention as herein above described, and many apparently widely different embodiments of same made, it is intended that all matter contained in the accompanying specification shall be interpreted as illustrative only and not in a limiting sense.

1. A charging apparatus for charging a drone relative to a supporting structure at an elevated location using a power supply, the charging apparatus comprising:
a mounting frame arranged for attachment to the drone to extend upwardly above the drone;
a catch formed on a connecting portion of the mounting frame;
first terminals mounted on the mounting frame so as to be arranged for electrical communication with respective charging terminals of the drone;
a docking station arranged to be mounted on the supporting structure at said elevated location such that the drone can approach the docking station from below;
a receiver on the docking station including a socket arranged to receive the connecting portion of the mounting frame inserted upwardly therein in a docked position of the mounting frame relative to the docking station;
second terminals arranged for connection to the power supply, the second terminals being mounted on the docking station so as to be arranged for electrical communication with the first terminals respectively in the docked position of the mounting frame relative to the docking station whereby the charging terminals of the drone are charged from the power supply; and
a latch mounted on the docking station so as to be operable between (i) a latched configuration engaged with the catch on the mounting frame so as to retain the mounting frame in the docked position and (ii) a released configuration in which the mounting frame is freely movable downwardly from the docked position to allow withdrawal of the mounting frame from the receiver on the docking station.

2. The charging apparatus according to claim 1 wherein the receiver is tapered upwardly and laterally inwardly towards the socket to guide insertion of the connecting portion of the mounting frame upwardly into the socket of the receiver as the mounting frame is displaced towards the docked position.

3. The charging apparatus according to claim 1 wherein the receiver includes a guide wall that is generally conical in shape so as to guide insertion of the connecting portion upwardly and laterally inwardly from all directions towards the socket.

4. The charging apparatus according to claim 1 wherein the guide wall is generally convex along at least a portion of a height of the guide wall between a bottom peripheral edge of the guide wall and the socket at a top end of the guide wall.

5. The charging apparatus according to claim 1 wherein the receiver receives the connecting portion of the mounting frame therein in the docked position such that the mounting frame is suspended from the receiver and is able to be deflected laterally in all directions from the docked position by pivoting of the mounting frame about a central point of the connecting portion received within the socket.

6. The charging apparatus according to claim 1 wherein a top of the connecting portion is tapered upwardly and inwardly in all direction towards a central apex of the connecting portion.

7. The charging apparatus according to claim 1 wherein the latch is horizontally slidable between the latched configuration and the released configuration.

8. The charging apparatus according to claim 1 wherein the catch extends 360 degrees about an upright axis of the connecting portion of the mounting frame.

9. The charging apparatus according to claim 1 wherein the connecting portion of the mounting frame comprises an upright post.

10. The charging apparatus according to claim 9 wherein the catch is defined as a bottom surface of a radial enlargement formed on the upright post.

11. The charging apparatus according to claim 10 wherein the bottom surface of the radial enlargement is tapered downwardly and inwardly about a full circumference of the upright post.

12. The charging apparatus according to claim 9 wherein the mounting frame further comprises a plurality of radial supporting arms arranged for connection between the upright post and respective frame arms of the drone.

13. The charging apparatus according to claim 9 wherein the upright post comprises a hollow tube receiving electrical wiring communicating therethrough between the first terminals of the mounting frame and the charging terminals of the drone.

14. The charging apparatus according to claim 1 wherein the first terminals are supported on the mounting frame above the catch.

15. The charging apparatus according to claim 1 wherein the first terminals include a positive terminal and a negative terminal which are vertically spaced apart from one another.

16. The charging apparatus according to claim 1 wherein one of the first terminals is defined at a top end of the mounting frame.

17. The charging apparatus according to claim 1 wherein one of the first terminals is defined by the catch.

18. The charging apparatus according to claim 1 further comprising a roof structure mounted in fixed relation to the docking station, the roof structure being sized to fully span over the drone in the docked position of the mounting frame relative to the docking station.

19. The charging apparatus according to claim 1 wherein the roof structure extends downwardly to a bottom peripheral edge arranged to be located below a portion of the mounting frame in elevation so as to be arranged to shelter the drone in a lateral direction.

20. A method of docking a drone relative to a supporting structure at an elevated location for charging the drone using a power supply, the method comprising:
providing a mounting frame attached to the drone to extend upwardly from the drone in which the mounting frame includes a connecting portion forming a catch thereon and first terminals for electrical communication with respective charging terminals of the drone;
providing a docking station mounted on the supporting structure at said elevated location such that the drone can approach the docking station from below, in which the docking station includes a receiver forming a socket therein, second terminals connected to the power supply, and a latch;
operating the drone to fly upwardly towards the docking station such that the connecting portion of the mounting frame is inserted upwardly into the socket of the receiver into a docked position of the mounting frame relative to the docking station; and
operating the latch on the docking station from (i) a released configuration in which the mounting frame is freely movable downwardly from the docked position to allow withdrawal of the mounting frame from the receiver on the docking station and (ii) a latched configuration engaged with the catch on the mounting frame so as to retain the mounting frame in the docked position;
wherein the first terminals of the mounting frame electrically communicate
with the second terminals on the docking station in the docked position whereby the charging terminals of the drone are charged from the power supply.
